(19) United States
(12) Patent Application Publication
(10) Pub. No.: US 2014/0204862 A1
(43) Pub. Date: Jul. 24, 2014

(54) SIGNALING TRANSMITTING METHOD, USER EQUIPMENT, AND BASE STATION

(71) Applicant: Huawei Technologies Co., Ltd., Shenzhen (CN)

(72) Inventors: Yi YANG, Shanghai (CN); Meng HUA, Shanghai (CN); Shuju FAN, Shanghai (CN)

(73) Assignee: Huawei Technologies Co., Ltd., Shenzhen (CN)

(21) Appl. No.: 14/158,429

(22) Filed: Jan. 17, 2014

(30) Foreign Application Priority Data
Jan. 22, 2013 (CN) 201310027275.X

(51) Int. Cl. H04W 52/04; H04L 5/00

(52) U.S. Cl. CPC H04W 52/04; H04L 5/0053
USPC 370/329

(57) ABSTRACT

The present invention provides a signaling transmitting method, a user equipment and a base station. In the present invention, a first DPCCH is transmitted to a base station over an uplink main carrier, where information borne over the first DPCCH at least includes: first Pilot information, downlink TPC information, and the downlink TPC is at least used for the base station to perform power control on a downlink main carrier; and a second DPCCH is transmitted to the base station over an uplink secondary carrier, where the second DPCCH is used to bear uplink signaling, and the uplink signaling is second Pilot information, or, the uplink signaling is the second Pilot information and TFCI information, or, the uplink signaling is the second Pilot information and FBI information, or, the uplink signaling is the second Pilot information, the TFCI information and the FBI information.

### CROSS-REFERENCE TO RELATED APPLICATION

This application claims priority to Chinese Patent Application No. 201310027275.X, filed on Jan. 22, 2013, which is hereby incorporated by reference in its entirety.

### TECHNICAL FIELD

The present invention relates to the field of communications technologies, and in particular, to a signaling transmitting method, a user equipment and a base station.

### BACKGROUND

With the rapid development of communications technologies, the wideband code division multiple access has been widely studied and applied on a global scale as one of the mainstream technologies in the third generation mobile communications system. There are Release 6 (Release 6, R6), Release 7 (Release 7, R7), . . . , Release 11 (Release 11, R11), and so on for 3GPP. In order to increase a data transfer rate and meet different requirements, the high speed downlink packet access (High Speed Downlink Packet Access, HSDPA) technology is introduced in R5 in UMTS (Universal Mobile Telecommunications System, Universal Mobile Telecommunications System), so that a downlink can achieve a speed up to 14.4 Mbit/s; and high speed uplink packet access (High Speed Uplink Packet Access, HSUPA) is introduced in R6. In order to further increase a data transfer rate of an HSPA system, the DC-HSDPA (Dual-Cell HSDPA, dual-cell HSDPA) technology is introduced in an R8 version, where a configuration of two carriers for a downlink and one single carrier for an uplink is used, a UE can receive data transmitted from high speed downlink shared channels (HS-DSCH, High Speed Downlink Shared Channel) of two downlink carriers simultaneously; where a downlink carrier associated with an uplink carrier is called a main carrier, and the other carrier is called a secondary carrier.

The HSPA multi-carrier technology is evolved continuously in the R9 version, and the DC-HSUPA (Dual-Cell HSUPA, dual-cell HSUPA) technology is introduced, that is: by using two carriers for an uplink, a UE can use an enhanced dedicated channel (E-DCH, Enhanced Dedicated Channel) of two uplink carriers to transmit uplink data; where an uplink carrier associated with a downlink main carrier the is called an uplink main carrier, the other carrier is called an uplink secondary carrier, which is associated with a downlink secondary carrier. On each uplink carrier, uplink power control and downlink power control are performed independently.

In a communications system using the DC-HSUPA technology, transmit power resources are shared between each carrier. Because one carrier takes up power surely causes available power of another carrier to be reduced, how to reduce unnecessary signaling overhead while guarantee transmit power of an uplink main carrier in a multi-carrier mode is one of to-be-solved problems for the multi-carrier technology currently.

### SUMMARY

In order to solve the problem in the prior art, embodiments of the present invention provide a signaling transmitting method, a user equipment, and a base station. The technical solutions are as follows:

In a first aspect, an embodiment of the present invention provides a signaling transmitting method, which includes: transmitting a first dedicated physical control channel DPCCH to a base station over an uplink main carrier, where information borne over the first DPCCH at least includes: first Pilot information, and downlink transmit power control command TPC information, where the downlink TPC is at least used for the base station to perform power control on a downlink main carrier; and transmitting a second DPCCH to the base station over an uplink secondary carrier, where the second DPCCH is used to bear uplink signaling, and the uplink signaling is second Pilot information, or, the uplink signaling is the second Pilot information and transport format combination indication TFCI information, or, the uplink signaling is the second Pilot information and feedback information FBI information, or, the uplink signaling is the second Pilot information, the transport format combination indication TFCI information, and the feedback information FBI information.

In a first possible implementation manner of the first aspect, the transmitting a second DPCCH to the base station over an uplink secondary carrier includes: if the uplink secondary carrier uses a transmit diversity mode or a multiple-input multiple-output mode, transmitting a secondary dedicated physical control channel S-DPCCH to the base station over the uplink secondary carrier, and transmitting the second DPCCH to the base station over the uplink secondary carrier, where the second DPCCH is used to bear the uplink signaling, and the uplink signaling is the second Pilot information.

In a second possible implementation manner of the first aspect, the downlink TPC information includes: first downlink TPC, where the first downlink TPC is used for the base station to perform power control on the downlink main carrier; or, the downlink TPC information includes: the first downlink TPC and second downlink TPC, where the first downlink TPC is used for the base station to perform power control on the downlink main carrier, and the second downlink TPC is used for the base station to perform power control on a downlink secondary carrier.

In a second aspect, an embodiment of the present invention provides a signaling transmitting method, which includes: transmitting a third channel to a user equipment UE over a downlink main carrier, where information borne over the third channel at least includes: uplink transmit power control command TPC information, where the uplink TPC is used for the UE to perform power control on an uplink main carrier and an uplink secondary carrier.

In a first possible implementation manner of the second aspect, the method further includes: transmitting a fourth channel to the UE over a downlink secondary carrier, where the fourth channel is used to bear downlink signaling, and the downlink signaling is fourth Pilot information, or, the downlink signaling is transport format combination indication TFCI information, or, the downlink signaling is the fourth Pilot information and the transport format combination indication TFCI information.

In a second possible implementation manner of the second aspect, the uplink TPC information includes: first uplink TPC, where the first uplink TPC is used for the UE to perform power control on the uplink main carrier and the uplink secondary carrier; or, the uplink TPC information includes: the first uplink TPC and second uplink TPC, where the first uplink TPC is used for the UE to perform power control on the uplink main carrier, and the second uplink TPC is used for the UE to perform power control on the uplink secondary carrier.

In a third aspect, an embodiment of the present invention provides a user equipment, which includes: a first transmitter, configured to transmit a first dedicated physical control channel DPCCH to a base station over an uplink main carrier, where information borne over the first DPCCH at least includes: first pilot Pilot information, and downlink transmit power control command TPC information, where the downlink TPC is at least used for the base station to perform power control on a downlink main carrier; and a second transmitter, configured to transmit a second DPCCH to the base station over an uplink secondary carrier, where the second DPCCH is used to bear uplink signaling, and the uplink signaling is second Pilot information, or, the uplink signaling is the second Pilot information and transport format combination indication TFCI information, or, the uplink signaling is the second Pilot information and feedback information FBI information, or, the uplink signaling is the second Pilot information, the transport format combination indication TFCI information, and the feedback information FBI information.

In a first possible implementation manner of the third aspect, the second transmitter is configured to: if the uplink secondary carrier uses a transmit diversity mode or a multiple-input multiple-output mode, transmit a secondary dedicated physical control channel S-DPCCH to the base station over the uplink secondary carrier, and transmit the second DPCCH to the base station over the uplink secondary carrier, where the second DPCCH is used to bear the uplink signaling, and the uplink signaling is the second Pilot information.

In a second possible implementation manner of the third aspect, the downlink TPC information includes: first downlink TPC, where the first downlink TPC is used for the base station to perform power control on the downlink main carrier; or, the downlink TPC information includes: the first downlink TPC and second downlink TPC, where the first downlink TPC is used for the base station to perform power control on the downlink main carrier, and the second downlink TPC is used for the base station to perform power control on a downlink secondary carrier.

In a fourth aspect, an embodiment of the present invention provides a base station, which includes: a third transmitter, configured to transmit a third channel to a user equipment UE over a downlink main carrier, where information borne over the third channel at least includes: uplink transmit power control command TPC information, where the uplink TPC is used for the UE to perform power control on an uplink main carrier and an uplink secondary carrier.

In a first possible implementation manner of the fourth aspect, the base station further includes: a fourth transmitter, configured to transmit a fourth channel to the UE over a downlink secondary carrier, where the fourth channel is used to bear downlink signaling, and the downlink signaling is fourth Pilot information, or, the downlink signaling is transport format combination indication TFCI information, or, the downlink signaling is the fourth Pilot information and the transport format combination indication TFCI information.

In the first possible implementation manner of the four aspect, the uplink TPC information includes: first uplink TPC, where the first uplink TPC is used for the UE to perform power control on the uplink main carrier and the uplink secondary carrier; or, the uplink TPC information includes: the first uplink TPC and second uplink TPC, where the first uplink TPC is used for the UE to perform power control on the uplink main carrier, and the second uplink TPC is used for the UE to perform power control on the uplink secondary carrier.

In the signaling transmitting method, the user equipment, and the base station provided by the embodiments of the present invention, a first dedicated physical control channel DPCCH is transmitted to a base station over an uplink main carrier, where information borne over the first DPCCH at least includes: first pilot Pilot information, and downlink transmit power control command TPC information, where the downlink TPC is at least used for the base station to perform power control on a downlink main carrier; and a second DPCCH is transmitted to the base station over an uplink secondary carrier, where the second DPCCH is used to bear uplink signaling, and the uplink signaling is second Pilot information, or, the uplink signaling is the second Pilot information and transport format combination indication TFCI information, or, the uplink signaling is the second Pilot information and feedback information FBI information, or, the uplink signaling is the second Pilot information, the transport format combination indication TFCI information, and the feedback information FBI information. By adopting the technical solutions in the embodiment of the present invention, under a multi-carrier mode, when power control is being performed, a transmit power control command is not transmitted over the secondary carrier, and therefore, in a condition that normal business is not affected, unnecessary signaling overhead is reduced, client throughput is increased, and system spectrum effectiveness is improved.

### BRIEF DESCRIPTION OF DRAWINGS

To illustrate the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a flow chart of a signaling transmitting method provided in an embodiment of the present invention;

FIG. 2 is a flow chart of a transmit power control method provided in an embodiment of the present invention;

FIG. 3 is a flow chart of a signaling transmitting method provided in an embodiment of the present invention;

FIG. 4 is a flow chart of a transmit power control method provided in an embodiment of the present invention;

FIG. 5 is a schematic structural diagram of a user equipment provided in an embodiment of the present invention; and

FIG. 6 is a schematic structural diagram of a base station provided in an embodiment of the present invention.

### DESCRIPTION OF EMBODIMENTS

To make the objectives, technical solutions, and advantages of the present invention more comprehensible, the following further describes the embodiments of the present invention in detail with reference to the accompanying drawings.

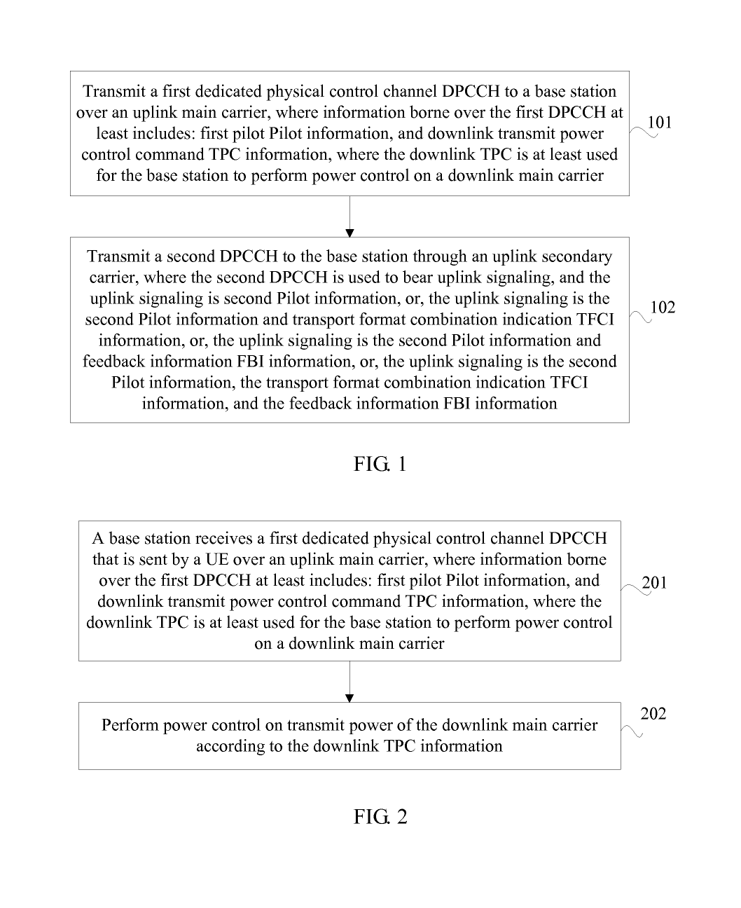

FIG. 1 is a flow chart of a signaling transmitting method provided in an embodiment of the present invention. An executor of this embodiment is a UE (User Equipment, user equipment), and with reference to FIG. 1, the following is included:

101. Transmit a first dedicated physical control channel DPCCH to a base station over an uplink main carrier, where information borne over the first DPCCH at least includes: first pilot Pilot information, and downlink transmit power control command TPC information, and the downlink TPC is at least used for the base station to perform power control on a downlink main carrier.

The downlink TPC information carries information of requesting the base station to increase or reduce the downlink transmit power.

If uplink main and secondary carriers do not support a DCH (Dedicated Channel, dedicated channel) service, but support an E-DCH service, the information borne over the first DPCCH (Dedicated Physical Control Channel, dedicated physical control channel) may include only the first pilot Pilot information, and the downlink transmit power control command TPC (Transmit Power Control, transmit power control) information. If a condition that the DCH service is supported is considered, the information borne over the first DPCCH may include the first pilot Pilot information, the downlink transmit power control command TPC information, TFCI (Transport Format Combination Indicator, transport format combination indicator) and FBI (Feedback Information, feedback information).

102. Transmit a second DPCCH to the base station over an uplink secondary carrier, where the second DPCCH is used to bear uplink signaling, and the uplink signaling is second Pilot information, or, the uplink signaling is the second Pilot information and transport format combination indication TFCI information, or, the uplink signaling is the second Pilot information and feedback information FBI information, or, the uplink signaling is the second Pilot information, the transport format combination indication TFCI information, and the feedback information FBI information.

In the embodiment of the present invention, when the UE is configured to be in a uplink multi-carrier mode, the UE does not transmit the downlink TPC information on the uplink secondary carrier, that is to say, the UE transmits the downlink TPC information to the base station only over the uplink main carrier, so that the base station performs transmit power control, according to the received downlink transmit power control command, on the downlink main carrier corresponding to the uplink main carrier, and does not control the transmit power of the downlink secondary carrier. Because information such as a control information indication, data transmitting, data scheduling and channel state feedback is simplified on the secondary carrier, system performance is optimized.

It should be noted that the foregoing steps 101 and 102 are not subject to a time sequence, and may be performed synchronously.

The condition that the UE transmits the downlink TPC information to the base station only over the uplink main carrier, and does not transmit the downlink TPC information on the uplink secondary carrier may include any one of the following:

(I) The uplink signaling is the second Pilot information.

In the embodiment of the present invention, when the UE is configured to be in the uplink multi-carrier mode, the main and secondary carriers do not support DCH, but support only the E-DCH service, and therefore, over the uplink secondary carrier, the DPCCH bearing the uplink signaling can be transmitted, the uplink signaling is pilot Pilot (which is referred to as the second Pilot information in the embodiment of the present invention), a timeslot format of the DPCCH may be an S-DPCCH (Secondary-DPCCH, secondary DPCCH), and its timeslot format is shown in Table 1 below. The uplink S-DPCCH timeslot format only include two information domains: pilot Pilot and preset value fixed.

TABLE 1

| | | | | | | | | Transmitted |
|---|---|---|---|---|---|---|---|---|
| Slot | Channel | Channel | | | | | | slots per |
| Format | Bit Rate | Symbol | | Bits/ | Bits/ | | | radio |
| #i | (kbps) | Rate (ksps) | SF | Frame | Slot | Nₚᵢₗₒₜ | N_{fixed} | frame |
| 1 | 15 | 15 | 256 | 150 | 10 | 8 | 2 | 8-15 |

Because the UE transmits the S-DPCCH that bears only the pilot Pilot, but no longer bears TPC, TFCI (Transport Format Combination Indicator, transport format combination indicator) or FBI (Feedback Information, feedback information), and because the carried information domain is reduced, the uplink transmit power is reduced.

In another embodiment of the present invention, a DPCCH timeslot format that is only used to bear pilot may further be provided, and the timeslot format is shown in Table 2 below. The uplink DPCCH timeslot format includes only a pilot Pilot information domain.

TABLE 2

| | Channel | | | | | | | | | Transmitted |
|---|---|---|---|---|---|---|---|---|---|---|
| Slot | Bit | Channel | | | | | | | | slots per |
| Format | Rate | Symbol | | Bits/ | Bits/ | | | | | radio |
| #i | (kbps) | Rate (ksps) | SF | Frame | Slot | Nₚᵢₗₒₜ | N_{TPC} | N_{TFCI} | N_{FBI} | frame |
| 5 | 15 | 15 | 256 | 150 | 10 | 10 | 0 | 0 | 0 | 8-15 |

Specifically, when the uplink secondary carrier uses a single-antenna transmit mode, the UE transmits the second DPCCH to the base station over the uplink secondary carrier, where the second DPCCH is used to bear the uplink signaling, and the uplink signaling is the second Pilot information.

If the uplink secondary carrier uses a transmit diversity mode, the S-DPCCH is transmitted to the base station over the uplink secondary carrier, and the second DPCCH is transmitted to the base station over the uplink secondary carrier, where the second DPCCH is used to bear the uplink signaling, and the uplink signaling is the second Pilot information.

If the uplink secondary carrier uses a multiple-input multiple-output mode, the S-DPCCH is transmitted to the base station over the uplink secondary carrier, and the second DPCCH is transmitted to the base station over the uplink secondary carrier, where the second DPCCH is used to bear the uplink signaling, and the uplink signaling is the second Pilot information.

It should be noted that, under the transmit diversity mode and multiple-input multiple-output mode, transmission of the S-DPCCH and the second DPCCH may be performed simultaneously.

(II) The uplink signaling is the second Pilot information and the transport format combination indication TFCI information.

In this embodiment, in order to support the DCH service over the uplink secondary carrier, a newly provided uplink DPCCH timeslot format may further be adopted. The DPCCH bearing the uplink signaling may be transmitted over the uplink secondary carrier, where the uplink signaling includes only pilot Pilot and TFCI. The DPCCH timeslot format is shown in Table 3 below, and the uplink DPCCH timeslot format includes only two information domains, namely, pilot and TFCI.

TABLE 3

| Slot | Channel | Channel | | | | | | | | Transmitted |
|---|---|---|---|---|---|---|---|---|---|---|
| Format | Bit Rate | Symbol | | Bits/ | Bits/ | | | | | slots per |
| #i | (kbps) | Rate (ksps) | SF | Frame | Slot | Nₚᵢₗₒₜ | N_{TPC} | N_{TFCI} | N_{FBI} | radio frame |
| 5 | 15 | 15 | 256 | 150 | 10 | 8 | 0 | 2 | 0 | 8-15 |
| 5 | 15 | 15 | 256 | 150 | 10 | 6 | 0 | 4 | 0 | 8-15 |
| 5 | 15 | 15 | 256 | 150 | 10 | 7 | 0 | 3 | 0 | 8-15 |

(III) The uplink signaling is the second Pilot information and the feedback information FBI information.

In this embodiment, in order to support the DCH service over the uplink secondary carrier, the DPCCH bearing the uplink signaling may be transmitted over the uplink secondary carrier, where the uplink signaling includes only pilot Pilot and FBI.

(IV) The uplink signaling is the second Pilot information, the transport format combination indication TFCI information, and the feedback information FBI information.

In this embodiment, in order to support the DCH service over the uplink secondary carrier, a newly provided uplink DPCCH timeslot format may further be adopted. The DPCCH bearing the uplink signaling may be transmitted over the uplink secondary carrier, where the uplink signaling includes only pilot Pilot, TFCI, and FBI.

By adopting the technical solutions in the embodiment of the present invention, when power control is being performed, a transmit power control command is not transmitted over the secondary carrier, and therefore, in a condition that normal business is not affected, unnecessary signaling overhead is reduced, client throughput is increased, and system spectrum effectiveness is improved.

Optionally, based on the technical solutions in the embodiment described in FIG. 1, the downlink TPC information may be in any one of the following two forms according to different communications system configurations:

(1) The downlink TPC information includes: first downlink TPC, where the first downlink TPC is used for the base station to perform power control on the downlink main carrier.

In the embodiment of the present invention, in order to save signaling overhead, power control is performed only on the downlink main carrier, and power control is not performed on the downlink secondary carrier alone. When the UE is configured to be in an uplink multi-carrier mode, the UE transmits the downlink TPC information over the uplink main carrier, where the downlink TPC includes the first downlink TPC. When the base station receives the first downlink TPC, power control is performed, according to the first downlink TPC, on the uplink main carrier corresponding to the first downlink TPC.

(2) The downlink TPC information includes: the first downlink TPC and second downlink TPC, where the first downlink TPC is used for the base station to perform power control on the downlink main carrier, and the second downlink TPC is used for the base station to perform power control on a downlink secondary carrier.

In order to reduce the signaling overhead when performing power control on the secondary carrier, the downlink TPC information may include the first downlink TPC and the second downlink TPC, where the second downlink TPC may be one or more command words, and each second downlink TPC may be associated with different uplink secondary carriers and is used for the base station to perform power control on multiple uplink secondary carriers of the UE.

FIG. 2 is a flow chart of a transmit power control method provided in an embodiment of the present invention. An executor of this embodiment is a base station, and with reference to FIG. 2, the following is included:

201. The base station receives a first dedicated physical control channel DPCCH transmitted by the UE over an uplink main carrier, where information borne over the first DPCCH at least includes: first pilot Pilot information, and downlink transmit power control command TPC information, and the downlink TPC is at least used for the base station to perform power control on a downlink main carrier.

In the embodiment of the present invention, in order to save signaling overhead, power control is performed only on the downlink main carrier, and power control is not performed on the downlink secondary carrier alone. When the UE is configured to be in an uplink multi-carrier mode, the UE does not transmit the downlink transmit power control command over the uplink main carrier, that is to say, the base station receives only the downlink transmit power control command transmitted by the UE over the uplink main carrier.

202. Power control is performed on transmit power of the downlink main carrier according to the downlink TPC information.

In the embodiment of the present invention, the base station may consider that the downlink transmit power control command is not only used to perform power control on the transmit power of the downlink main carrier, but may further be used to perform power control on transmit power of the downlink secondary carrier.

In an embodiment provided in the present invention, the downlink TPC information includes: first downlink TPC, where the first downlink TPC is used for the base station to perform power control on the downlink main carrier.

In the embodiment of the present invention, in order to save signaling overhead, power control is performed only on the downlink main carrier, and power control is not performed on the downlink secondary carrier alone. When the UE is configured to be in an uplink multi-carrier mode, the UE transmits the downlink TPC information over the uplink main carrier, where the downlink TPC includes the first downlink TPC. When the base station receives the first downlink TPC, power control is performed, according to the first downlink TPC, on the downlink main carrier corresponding to the uplink main carrier.

In another embodiment provided in the present invention, the downlink TPC information includes: the first downlink TPC and the second downlink TPC, where the first downlink TPC is used for the base station to perform power control on the downlink main carrier, and the second downlink TPC is used for the base station to perform power control on a downlink secondary carrier.

In order to reduce the signaling overhead when performing power control on the secondary carrier, the downlink TPC information may include the first downlink TPC and the second downlink TPC, where the second downlink TPC may be one or more command words, and each second downlink TPC may be associated with different uplink secondary carriers and is used for the base station to perform power control on multiple uplink secondary carriers of the UE.

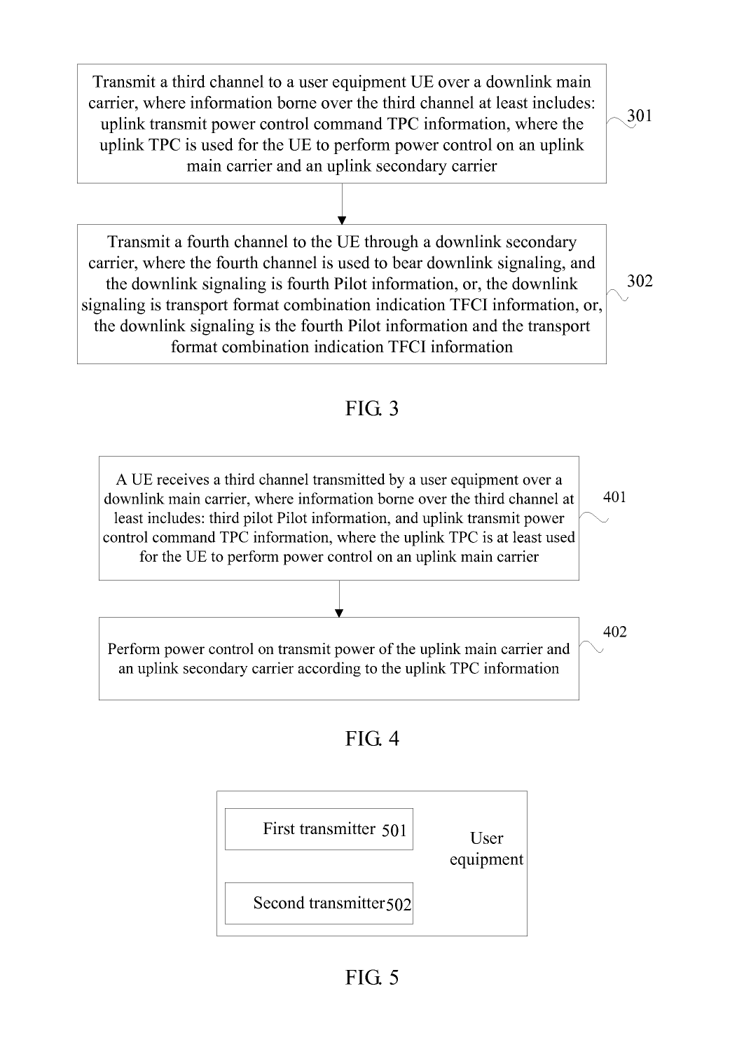

FIG. 3 is a flow chart of a signaling transmitting method provided in an embodiment of the present invention. An executor of this embodiment is a base station, and with reference to FIG. 3, the following is included:

301. Transmit a third channel to a user equipment UE over a downlink main carrier, where information borne over the third channel at least includes: uplink transmit power control command TPC information, where the uplink TPC is used for the UE to perform power control on an uplink main carrier and an uplink secondary carrier.

The third channel may be a DPCCH or an F-DPCH (Fractional-Dedicated Physical Control Channel, fractional-dedicated physical control channel). When the third channel is an F-DPCH channel, it bears only uplink TPC information; and when the third channel is a DPCCH channel, it may bear pilot, uplink TPC information, and so on. The uplink TPC information carries information of requesting the UE to increase or reduce the uplink transmit power.

It should be noted that, if the downlink secondary carrier has only an HSDPA service, it does not transmit the DPCCH channel or the F-DPCH channel, so as to save signaling overhead.

In another embodiment provided in the embodiment of the present invention, when the downlink secondary carrier supports a DCH service, the following step 302 is performed when the step 301 is performed:

302. Transmit a fourth channel to the UE over a downlink secondary carrier, where the fourth channel is used to bear downlink signaling, and the downlink signaling is fourth Pilot information, or, the downlink signaling is transport format combination indication TFCI information, or, the downlink signaling is the fourth Pilot information and the transport format combination indication TFCI information.

The fourth channel may be a DPCCH.

In the embodiment of the present invention, when the base station configures the UE to be in a downlink multi-carrier mode, the base station does not transmit the uplink TPC information over the downlink secondary carrier, that is to say, the base station transmits the uplink TPC information to the UE only over the downlink main carrier, so that the UE performs transmit power control, according to the received uplink TPC information, on the uplink main carrier corresponding to the downlink main carrier, and controls, according to the received uplink TPC information, the transmit power of the uplink secondary carrier corresponding to the downlink secondary carrier. Because information such as a control information indication, data transmitting, data scheduling and channel state feedback is simplified on the secondary carrier, system performance is optimized.

When the downlink secondary carrier supports the DCH service, a condition that the base station transmits the uplink TPC information to the UE only over the downlink main carrier, and does not transmit the uplink TPC information over the downlink secondary carrier may include any one of the following:

(I) The downlink signaling is fourth Pilot information.

In the embodiment of the present invention, when the base station configures the UE to be in a downlink multi-carrier mode, at the downlink secondary carrier, the UE may transmit the DPCCH channel that bears only pilot, but does not bear TPC, TFCI (Transport Format Combination Indicator, transport format combination indicator). Because the carried information domain is reduced, the downlink transmit power is reduced. Because the TFCI is not transmitted, the UE needs to perform a blind test on a data transport format when demodulating a data channel.

(II) The downlink signaling is the transport format combination indication TFCI information.

In this embodiment, in order to support the DCH service over the downlink secondary carrier, a newly provided downlink channel timeslot format may further be adopted. The DPCCH bearing the downlink signaling may be transmitted over the downlink secondary carrier, where the downlink signaling includes only TFCI. That is, the downlink channel timeslot format includes only the TFCI information domain.

(III) The downlink signaling is the fourth Pilot information and the transport format combination indication TFCI information.

In this embodiment, in order to support the DCH service over the downlink secondary carrier, a newly provided downlink DPCCH timeslot format may further be adopted. The DPCCH bearing the downlink signaling may be transmitted over the downlink secondary carrier, where the downlink signaling includes only pilot Pilot and TFCI.

By adopting the technical solutions in the embodiment of the present invention, under a multi-carrier UMTS mode, when power control is being performed, a transmit power control command is not transmitted over the secondary carrier, and therefore, in a condition that normal business is not affected, unnecessary signaling overhead is reduced, client throughput is increased, and system spectrum effectiveness is improved.

Optionally, based on the technical solutions in the embodiment described in FIG. 3, the uplink TPC information may be in any one of the following two forms according to different communications system configurations:

(1) The uplink TPC information includes: first uplink TPC, where the first uplink TPC is used for the UE to perform power control on the uplink main carrier and the uplink secondary carrier.

According to different configurations, same uplink TPC may be used to control the power of the uplink main carrier and the uplink secondary carrier, when power control is performed on the uplink secondary carrier, it may be performed according to the first uplink TPC and a preset policy, where the preset policy may be set on an operator side, the preset policy may be adjusted according to a preset value, and the adjustment includes but is not limited to increasing transmit power and reducing transmit power.

(2) The uplink TPC information includes: the first uplink TPC and second uplink TPC, where the first uplink TPC is used for the UE to perform power control on the uplink main carrier, and the second uplink TPC is used for the UE to perform power control on the uplink secondary carrier.

According to different configurations, each TPC included in the uplink TPC may be used to perform power control on the uplink main carrier and the uplink secondary carrier separately.

FIG. 4 is a flow chart of a transmit power control method provided in an embodiment of the present invention. An executor of this embodiment is a UE (User Equipment, user equipment), and with reference to FIG. 4, the following is included:

401. A UE receives a third channel transmitted by a base station over a downlink main carrier, where information borne over the third channel at least includes: uplink transmit power control command TPC information, where the uplink TPC is at least used for the UE to perform power control on an uplink main carrier.

In the embodiment of the present invention, in order to save signaling overhead, the uplink transmit power control command is only transmitted for the downlink main carrier, and the uplink transmit power control command is not transmitted over the downlink secondary carrier alone. When the UE is configured to be in an uplink multi-carrier mode, the UE receives the uplink transmit power control command transmitted by the base station over the downlink main carrier. The uplink TPC information may include multiple uplink TPC, and each uplink TPC may be associated with different main carriers or secondary carriers and is used to perform power control on multiple main carriers or secondary carriers of the UE separately.

402. Perform power control on transmit power of the uplink main carrier and the uplink secondary carrier according to the uplink TPC information.

When power control is performed on the uplink main carrier and at least one uplink secondary carrier of the UE, multiple uplink TPC included in the uplink TPC information may be used to perform power control on their respective associated carriers.

By adopting the technical solutions in the embodiment of the present invention, when power control is being performed, the UE receives only uplink TPC information over the downlink main carrier, and performs power control on the uplink main carrier and the uplink secondary carrier according to the uplink TPC information. Therefore, in a condition that normal business is not affected, unnecessary signaling overhead is reduced, client throughput is increased, and system spectrum effectiveness is improved.

Preferably, the foregoing embodiment may be applicable to a mutli-carrier scenario, and may further be applicable to a variable-bandwidth multi-carrier scenario, the bandwidth of each carrier in the variable-bandwidth multi-carrier UMTS is variable, so that carrier frequencies of different bandwidths may be configured. A chip rate of a conventional UMTS system is 3.84 MHz, and a single-carrier system is typically deployed at a 5 MHz frequency bandwidth. If a multi-carrier system is considered, the UMTS may be deployed at an integral multiple of the 5 MHz frequency spectrum. However, a frequency spectrum resource owned by an operator may be less than 5 MHz or is not the integral multiple of 5 MHz. If the conventional UMTS system deployment is adopted, it may result in a frequency spectrum fragment, reducing frequency spectrum utilization and causing a waste of frequency spectrum resources. When the carrier bandwidth less than 5 M is adopted, An operation on a physical layer is consistent with that in the conventional UMTS, but only a chip rate is reduced, existing hardware is changed as little as possible. A clock is adjusted N times slower, so that its bandwidth is reduced to 1/N of the standard bandwidth, where N is a positive integer. Using a dual-carrier as an example, a bandwidth of carrier 1 is 5 M, a bandwidth of the carrier 2 is 2.5 M (N=2), and in a variable-bandwidth multi-carrier scenario, a small carrier may selectively delete a synchronization/broadcast/common channel, and may even not send a voice service. Such a small carrier is called a light enhanced secondary carrier (light enhanced secondary carrier), is a non-standalone carrier (non-standalone), and must be aggregated with an original carrier. This light secondary carrier is relative to the network side. Under a multi-carrier network, the UE cannot acquire synchronization from the small carrier, and further cannot access the small carrier or receive a service. Therefore, by applying the embodiment provided in the present invention under the variable-bandwidth multi-carrier scenario, the signaling overhead can be reduced, and a bandwidth of the small carrier can be used at a maximum scale while avoiding affecting normal business.

FIG. 5 is a schematic structural diagram of a user equipment provided in an embodiment of the present invention, and with reference to FIG. 5, the user equipment includes:

a first transmitter 501, configured to transmit a first dedicated physical control channel DPCCH to a base station over an uplink main carrier, where information borne over the first DPCCH at least includes: first pilot Pilot information, and downlink transmit power control command TPC information, where the downlink TPC is at least used for the base station to perform power control on a downlink main carrier; and

a second transmitter 502, configured to transmit a second DPCCH to the base station over an uplink secondary carrier, where the second DPCCH is used to bear uplink signaling, and the uplink signaling is second Pilot information, or, the uplink signaling is the second Pilot information and transport format combination indication TFCI information, or, the uplink signaling is the second Pilot information and feedback information FBI information, or, the uplink signaling is the second Pilot information, the transport format combination indication TFCI information, and the feedback information FBI information.

It should be noted that the first transmitter 501 and the second transmitter 502 may be implemented by multiplexing a same entity transmitter.

Optionally, the second transmitter 502 is configured to: if the uplink secondary carrier uses a transmit diversity mode or a multiple-input multiple-output mode, transmit a secondary dedicated physical control channel S-DPCCH to the base station over the uplink secondary carrier, and transmit the second DPCCH to the base station over the uplink secondary carrier, where the second DPCCH is used to bear the uplink signaling, and the uplink signaling is the second Pilot information.

Optionally, the downlink TPC information includes: first downlink TPC, where the first downlink TPC is used for the base station to perform power control on the downlink main carrier; or the downlink TPC information includes: the first downlink TPC and second downlink TPC, where the first downlink TPC is used for the base station to perform power control on the downlink main carrier, and the second downlink TPC is used for the base station to perform power control on a downlink secondary carrier.

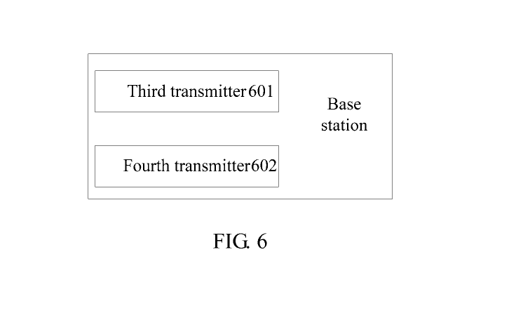

FIG. 6 is a schematic structural diagram of a base station provided in an embodiment of the present invention, and with reference to FIG. 6, the base station includes:

a third transmitter 601, configured to transmit a third channel to a user equipment UE over a downlink main carrier, where information borne over the third channel at least includes: uplink transmit power control command TPC information, where the uplink TPC is used for the UE to perform power control on an uplink main carrier and an uplink secondary carrier.

Optionally, the base station further includes: a fourth transmitter 602, configured to transmit a fourth channel to the UE over a downlink secondary carrier, where the fourth channel is used to bear downlink signaling, and the downlink signaling is fourth Pilot information, or, the downlink signaling is transport format combination indication TFCI information, or, the downlink signaling is the fourth Pilot information and the transport format combination indication TFCI information.

It should be noted that the third transmitter 601 and the fourth transmitter 602 may be implemented by multiplexing a same entity transmitter.

Optionally, the uplink TPC information includes: first uplink TPC, where the first uplink TPC is used for the UE to perform power control on the uplink main carrier and the uplink secondary carrier; or

the uplink TPC information includes: the first uplink TPC and second uplink TPC, where the first uplink TPC is used for the UE to perform power control on the uplink main carrier, and the second uplink TPC is used for the UE to perform power control on the uplink secondary carrier.

A person of ordinary skill in the art may understand that all or a part of the steps of the foregoing embodiments may be implemented by hardware, or may be implemented by a program instructing relevant hardware. The program may be stored in a computer readable storage medium. The storage medium may be a read-only memory, a magnetic disc, an optical disc, or the like.

The foregoing descriptions are merely exemplary embodiments of the present invention, but are not intended to limit the present invention. Any modifications, equivalent replacements, improvements, or the like made within the spirit and principle of the present invention shall fall within the protection scope of the present invention.

What is claimed is that:

1. A signaling transmitting method, comprising:
transmitting a first dedicated physical control channel DPCCH to a base station over an uplink main carrier, wherein information borne over the first DPCCH at least comprises: first pilot Pilot information, and downlink transmit power control command TPC information, wherein the downlink TPC is at least used for the base station to perform power control on a downlink main carrier; and
transmitting a second DPCCH to the base station over an uplink secondary carrier, wherein the second DPCCH is used to bear uplink signaling, and the uplink signaling is second Pilot information, or, the uplink signaling is the second Pilot information and transport format combination indication TFCI information, or, the uplink signaling is the second Pilot information and feedback information FBI information, or, the uplink signaling is the second Pilot information, the transport format combination indication TFCI information, and the feedback information FBI information.

2. The method according to claim 1, wherein the transmitting a second DPCCH to the base station over an uplink secondary carrier comprises:
if the uplink secondary carrier uses a transmit diversity mode or a multiple-input multiple-output mode, transmitting a secondary dedicated physical control channel S-DPCCH to the base station over the uplink secondary carrier, and transmitting the second DPCCH to the base station over the uplink secondary carrier, wherein the second DPCCH is used to bear the uplink signaling, and the uplink signaling is the second Pilot information.

3. The method according to claim 1, wherein the downlink TPC information comprises: first downlink TPC, wherein the first downlink TPC is used for the base station to perform power control on the downlink main carrier; or,
the downlink TPC information comprises: the first downlink TPC and second downlink TPC, wherein the first downlink TPC is used for the base station to perform power control on the downlink main carrier, and the second downlink TPC is used for the base station to perform power control on a downlink secondary carrier.

4. A signaling transmitting method, comprising:
transmitting a third channel to a user equipment UE over a downlink main carrier, wherein information borne over the third channel at least comprises: uplink transmit power control command TPC information, wherein the uplink TPC is used for the UE to perform power control on an uplink main carrier and an uplink secondary carrier.

5. The method according to claim 4, further comprising: transmitting a fourth channel to the UE over a downlink secondary carrier, wherein the fourth channel is used to bear downlink signaling, and the downlink signaling is fourth Pilot information, or, the downlink signaling is transport format combination indication TFCI information, or, the downlink signaling is the fourth Pilot information and the transport format combination indication TFCI information.

6. The method according to claim 4, wherein, the uplink TPC information comprises: first uplink TPC, wherein the first uplink TPC is used for the UE to perform power control on the uplink main carrier and the uplink secondary carrier; or,
the uplink TPC information comprises: the first uplink TPC and second uplink TPC, wherein the first uplink TPC is used for the UE to perform power control on the uplink main carrier, and the second uplink TPC is used for the UE to perform power control on the uplink secondary carrier.

7. A user equipment, comprising:
a first transmitter, configured to transmit a first dedicated physical control channel DPCCH to a base station over an uplink main carrier, wherein information borne over the first DPCCH at least comprises: first pilot Pilot information, and downlink transmit power control command TPC information, wherein the downlink TPC is at least used for the base station to perform power control on a downlink main carrier; and
a second transmitter, configured to transmit a second DPCCH to the base station over an uplink secondary carrier, wherein the second DPCCH is used to bear uplink signaling, and the uplink signaling is second Pilot information, or, the uplink signaling is the second Pilot information and transport format combination indication TFCI information, or, the uplink signaling is the second Pilot information and feedback information FBI information, or, the uplink signaling is the second Pilot information, the transport format combination indication TFCI information, and the feedback information FBI information.

8. The user equipment according to claim 7, wherein the second transmitter is configured to: if the uplink secondary carrier uses a transmit diversity mode or a multiple-input multiple-output mode, transmit a secondary dedicated physical control channel S-DPCCH to the base station over the uplink secondary carrier, and transmit the second DPCCH to the base station over the uplink secondary carrier, wherein the second DPCCH is used to bear the uplink signaling, and the uplink signaling is the second Pilot information.

9. The user equipment according to claim 7, wherein the downlink TPC information comprises: first downlink TPC, wherein the first downlink TPC is used for the base station to perform power control on the downlink main carrier; or,
the downlink TPC information comprises: the first downlink TPC and second downlink TPC, wherein the first downlink TPC is used for the base station to perform power control on the downlink main carrier, and the second downlink TPC is used for the base station to perform power control on a downlink secondary carrier.

10. A base station, comprising:
a third transmitter, configured to transmit a third channel to a user equipment UE over a downlink main carrier, wherein information borne over the third channel at least comprises: uplink transmit power control command TPC information, wherein the uplink TPC is used for the UE to perform power control on an uplink main carrier and an uplink secondary carrier.

11. The base station according to claim 10, further comprising: a fourth transmitter, configured to transmit a fourth channel to the UE over a downlink secondary carrier, wherein the fourth channel is used to bear downlink signaling, and the downlink signaling is fourth Pilot information, or, the downlink signaling is transport format combination indication TFCI information, or, the downlink signaling is the fourth Pilot information and the transport format combination indication TFCI information.

12. The base station according to claim 10, wherein, the uplink TPC information comprises: first uplink TPC, wherein the first uplink TPC is used for the UE to perform power control on the uplink main carrier and the uplink secondary carrier; or,
the uplink TPC information comprises: the first uplink TPC and second uplink TPC, wherein the first uplink TPC is used for the UE to perform power control on the uplink main carrier, and the second uplink TPC is used for the UE to perform power control on the uplink secondary carrier.
